(19) United States
(12) Patent Application Publication
(10) Pub. No.: US 2024/0195139 A1
(43) Pub. Date: Jun. 13, 2024

(54) SYSTEMS AND METHODS USING A PAIR OF ROTATED VOLUME BRAGG GRATINGS FOR LASER AMPLIFICATION

(71) Applicant: University of Central Florida Research Foundation, Inc., Orlando, FL (US)

(72) Inventors: Ivan Divliansky, Orlando, FL (US); Ayman Abouraddy, Orlando, FL (US); Leonid Glebov, Orlando, FL (US); Oussama Mhibik, Oviedo, FL (US); Murat Yessenov, Orlando, FL (US)

(21) Appl. No.: 18/532,983

(22) Filed: Dec. 7, 2023

Related U.S. Application Data
(60) Provisional application No. 63/430,805, filed on Dec. 7, 2022.

(51) Int. Cl. H01S 3/08; H01S 3/10; H01S 3/106

(52) U.S. Cl. CPC H01S 3/08059; H01S 3/10053; H01S 3/106

(57) ABSTRACT

A laser device may include two rotated volume Bragg gratings (r-VBGs), where periods of the two r-VBGs are chirped along the respective grating vectors to vary along the respective grating vectors, where the two r-VBGs are spatially separated along a separation direction oriented at a non-zero angle to the grating vectors, and a gain medium between the two r-VBGs. A first of the two r-VBGs may reflect portions of an input beam from a seed laser source propagating along an incidence direction as a spectrally-spread beam. The gain medium may amplify the spectrally-spread beam when pumped. A second of the two r-VBGs may reflect portions of the spectrally-spread beam satisfying the Bragg condition into the incidence direction, wherein the second r-VBG is positioned to provide that the spectrally-spread beam is spectrally recombined into an output beam.

### CROSS-REFERENCE TO RELATED APPLICATION

The present application claims the benefit under 35 U.S.C. § 119(e) of U.S. Provisional Application Ser. No. 63/430,805, filed Dec. 7, 2022, which is incorporated herein by reference in the entirety.

### TECHNICAL FIELD

The present disclosure relates generally to laser amplification and, more particularly, to laser amplification using rotated volume Bragg gratings.

### BACKGROUND

Chirped pulse amplification (CPA) is a technique in which a laser pulse is temporally stretched prior to amplification and then recompressed after amplification. This configuration reduces a risk of damage to components of an amplifier since material damage thresholds are typically more dependent on peak power of a laser pulse than total optical power in a pulse. Traditional techniques providing chirped pulse amplification utilize a gain medium placed between two tilted diffraction gratings.

It is often highly desirable to miniaturize optical components to provide compact and robust implementation. However, in many cases, miniaturization of optical components does not eliminate free-space propagation requirements and thus provides only limited impact. For example, typical CPA techniques require tilting of bulk diffraction optics that require free space propagation of light, which limits possibilities for miniaturization. There is therefore a need to develop systems and methods to address the above deficiencies.

### SUMMARY

A laser device is disclosed, in accordance with one or more illustrative embodiments of the present disclosure. In embodiments, the laser device includes two rotated volume Bragg gratings (r-VBGs) formed as planes of refractive index variation with periodicity along parallel grating vectors, wherein periods of the two r-VBGs are chirped along the respective grating vectors to vary along the respective grating vectors, wherein the two r-VBGs are spatially separated along a separation direction oriented at a non-zero angle to the grating vectors. In embodiments, the laser device includes a gain medium between the two r-VBGs. In embodiments, a first of the two r-VBGs is configured to reflect portions of an input beam from a seed laser source propagating along an incidence direction satisfying a Bragg condition into the separation direction as a spectrally-spread beam, wherein the Bragg condition is satisfied for different wavelengths at different locations of the first r-VBG along the incidence direction to provide that a spectrum of the spectrally-spread beam is dispersed along the incidence direction. In embodiments, the gain medium amplifies the spectrally-spread beam when pumped. In embodiments, a second of the two r-VBGs is configured to reflect portions of the spectrally-spread beam satisfying the Bragg condition into the incidence direction, wherein the second r-VBG is positioned to provide that the Bragg condition is satisfied for different wavelengths at different locations of the first r-VBG along the incidence direction to provide that the spectrally-spread beam is spectrally recombined into an output beam.

In embodiments, a pulse duration of at least one of the seed beam or the output beam is shorter than 1 picosecond. In embodiments, a pulse duration of at least one of the seed beam or the output beam is shorter than 100 femtoseconds.

In embodiments, the laser device further includes a phase modulator between the two r-VBGs with a spatially non-uniform phase distribution in a plane orthogonal to the separation direction.

In embodiments, the first r-VBG is formed in a first material, wherein the second r-VBG is formed in a second material, wherein the phase modulator is located between the first and second r-VBGs without intervening components.

In embodiments, the phase modulator is in physical contact with at least one of the first or second r-VBGs.

In embodiments, the two r-VBGs and the phase modulator are formed in a single material.

In embodiments, the phase modulator is a two-dimensional phase modulator. In embodiments, the phase modulator is a one-dimensional phase modulator.

In embodiments, the input beam is a laser pulse, wherein the spatially non-uniform phase distribution of the phase modulator is selected to apply negative chirp to the laser pulse.

In embodiments, the non-zero angle is 45 degrees.

A laser device is disclosed, in accordance with one or more embodiments of the present disclosure. In embodiments, the laser device includes a seed laser source configured to generate an input beam. In embodiments, the laser device includes two rotated volume Bragg gratings (r-VBGs) formed as planes of refractive index variation with periodicity along parallel grating vectors, wherein periods of the two r-VBGs are chirped along the respective grating vectors to vary along the respective grating vectors, wherein the two r-VBGs are spatially separated along a separation direction oriented at a non-zero angle to the grating vectors. In embodiments, the laser device includes a gain medium between the two r-VBGs. In embodiments, a first of the two r-VBGs is configured to reflect portions of the input beam from the seed laser source propagating along an incidence direction satisfying a Bragg condition into the separation direction as a spectrally-spread beam, wherein the Bragg condition is satisfied for different wavelengths at different locations of the first r-VBG along the incidence direction to provide that a spectrum of the spectrally-spread beam is dispersed along the incidence direction. In embodiments, the gain medium amplifies the spectrally-spread beam when pumped. In embodiments, a second of the two r-VBGs is configured to reflect portions of the spectrally-spread beam satisfying the Bragg condition into the incidence direction, wherein the second r-VBG is positioned to provide that the Bragg condition is satisfied for different wavelengths at different locations of the first r-VBG along the incidence direction to provide that the spectrally-spread beam is spectrally recombined into an output beam.

A method is disclosed, in accordance with one or more illustrative embodiments of the present disclosure. In embodiments, the method includes reflecting, with a first rotated volume Bragg grating (r-VBG), portions of an input beam propagating along an incidence direction satisfying a Bragg condition as a spectrally-spread beam propagating along a separation direction, wherein the Bragg condition is satisfied for different wavelengths at different locations of the first r-VBG along the incidence direction to provide that a spectrum of the spectrally-spread beam is dispersed along the incidence direction. In embodiments, the method includes amplifying the spectrally-spread beam using a gain medium. In embodiments, the method includes reflecting, with a second r-VBG, portions of the spectrally-spread beam satisfying the Bragg condition as an output beam, wherein the second r-VBG is positioned to provide that the Bragg condition is satisfied for different wavelengths at different locations of the first r-VBG along the incidence direction to provide that the spectrally-spread beam is spectrally recombined into the output beam propagating along the incidence direction. In embodiments, the first and second r-VBGs are formed as planes of refractive index variation with periodicity along parallel grating vectors, wherein periods of the two r-VBGs are chirped along the respective grating vectors to vary along the respective grating vectors, wherein the two r-VBGs are spatially separated along the separation direction oriented at a non-zero angle to the grating vectors.

In embodiments, a pulse duration of at least one of the seed beam or the output beam shorter than 1 picosecond. In embodiments, a pulse duration of at least one of the seed beam or the output beam shorter than 100 femtoseconds.

In embodiments, a phase modulator between the two r-VBGs with a spatially non-uniform phase distribution in a plane orthogonal to the separation direction.

In embodiments, the first r-VBG is formed in a first material, wherein the second r-VBG is formed in a second material, wherein the phase modulator is located between the first and second r-VBGs without intervening components.

In embodiments, the phase modulator is in physical contact with at least one of the first or second r-VBGs.

In embodiments, the two r-VBGs and the phase modulator are formed in a single material.

In embodiments, the phase modulator is a two-dimensional phase modulator. In embodiments, the phase modulator is a one-dimensional phase modulator.

In embodiments, the input beam is a laser pulse, wherein the spatially non-uniform phase distribution of the phase modulator is selected to apply negative chirp to the laser pulse.

In embodiments, the non-zero angle is 45 degrees.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A is a top view of a rotated volume Bragg grating (r-VBG) with a uniform period, in accordance with one or more embodiments of the present disclosure.

FIG. 1B is a perspective view of the r-VBG of FIG. 1A, in accordance with one or more embodiments of the present disclosure.

FIG. 1C is a top view of an r-VBG with linear chirp along the grating vector direction, in accordance with one or more embodiments of the present disclosure.

FIG. 1D is a top view of a material including two multiplexed chirped r-VBGs 100 with different grating vector directions, in accordance with one or more embodiments of the present disclosure.

FIG. 1E is a simplified top view of an r-VBG 100 within a waveguide, in accordance with one or more embodiments of the present disclosure.

FIG. 1F is a simplified top view of a waveguide within an r-VBG, in accordance with one or more embodiments of the present disclosure.

FIG. 2A is a block diagram of a laser utilizing chirped pulse amplification with a pair of r-VBGs, in accordance with one or more embodiments of the present disclosure.

FIG. 2B is a block diagram of an amplifier, in accordance with one or more embodiments of the present disclosure.

FIG. 3 is a flow diagram illustrating steps performed in a method for light amplification using a pair of chirped r-VBGs, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods for laser amplification using one or more rotated volume Bragg gratings (r-VBGs).

As used herein an r-VBG is formed as a VBG having a grating vector direction of the rotated relative to an input face of a material or an expected direction of incident light. VBGs are generally described in Igor V. Ciapurin, et al., “Modeling of phase volume diffractive gratings, part 1: transmitting sinusoidal uniform gratings,” Optical Engineering 45 (2006) 015802, 1-9; and Igor V. Ciapurin, et al., “Modeling of phase volume diffractive gratings, part 2: reflecting sinusoidal uniform gratings, Bragg mirrors,” Optical Engineering 51 (2012) 058001, 1-10, both of which are incorporated herein by reference in their entireties. Further, transmissive VBGs (e.g., VBGs for which light satisfying a Bragg condition is diffracted as a transmitted beam) configured as transmissive phase masks are described generally in U.S. Patent Publication No. 2016/0116656 published on Apr. 28, 2016, which is incorporated herein by reference in its entirety.

In embodiments, a laser amplifier is placed between a pair of complementary chirped r-VBGs to provide compact, efficient, and robust spectral phase modulation. In this configuration, a first r-VBG has a grating vector direction oriented at a non-zero angle relative to an incidence direction of input light. It is contemplated herein that such a configuration may spatially resolve the spectrum of the input light in a highly compact package. In particular, such a configuration provides that a Bragg condition for reflection may be satisfied for different wavelengths at different depths of the chirped r-VBG.

An amplifier placed after the first r-VBG may then amplify the spectrally-spread light. In some embodiments, a phase modulator may also be placed after the first r-VBG before or after the amplifier may then introduce any one-dimensional or two-dimensional phase distribution to the spectrally-resolved input light.

A second r-VBG may then receive the light from the amplifier and recombine the spectral components to provide a beam having a beam profile that is substantially similar to the input light.

Notably, the resolution at which the spectrum of incident light is spatially spread or combined by an r-VBG depends on the particular distribution of the refractive index variation of the r-VBG along the propagation direction. As a result, such a device has no requirement for free-space propagation of the spectral components between the first and second r-VBGs and may thus provide an extraordinarily compact solution for applying tailored phase modulations to different spectral components of the input light.

It is contemplated herein that a spectral phase modulator as disclosed herein may be used to introduce any selected one-dimensional or two-dimensional phase profile to the spectrally-spread spectrum of input light. As a result, a spectral phase modulator as disclosed herein may be suitable for generating any type of output beam. In some embodiments, a spectral phase modulator is configured to generate a space-time wave packet (STWP) such as, but not limited to, a light sheet. In some embodiments, a spectral phase modulator is configured to provide spectral phase modification of ultrashort pulses. For example, the spectral components of ultrashort-pulse input light may be adjusted (e.g., pre-chirped) to provide that a pulse width of the output beam is minimized after propagating a selected distance in a selected material.

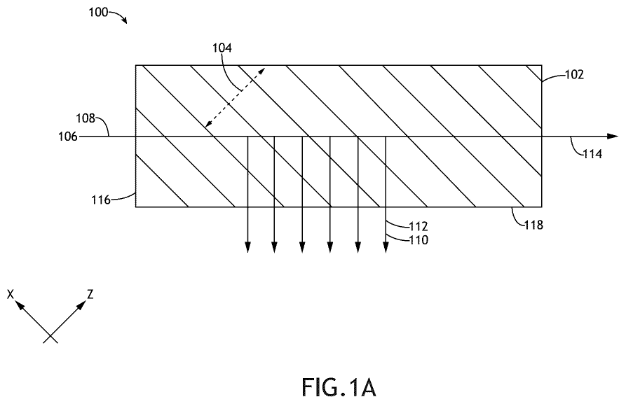

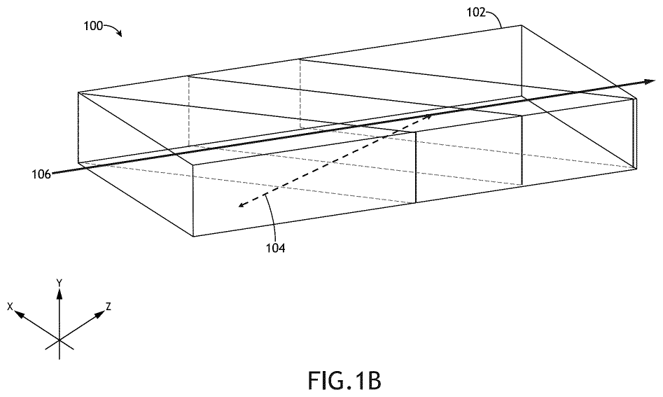

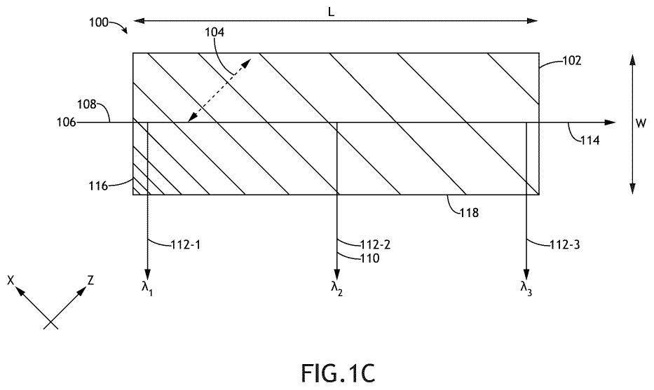

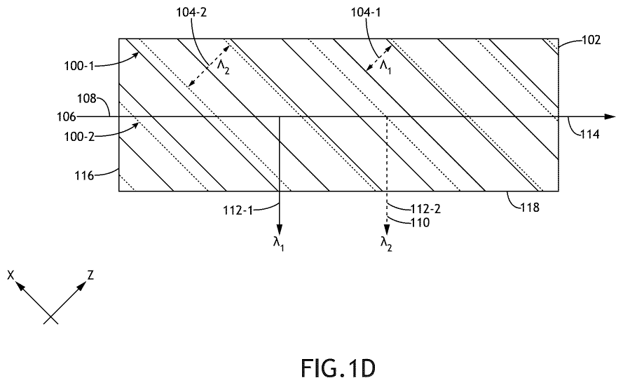

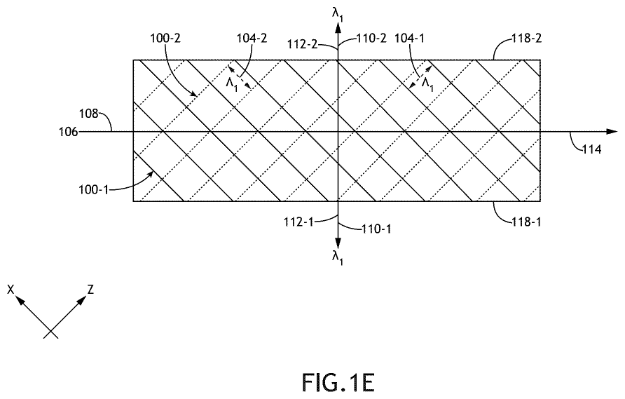

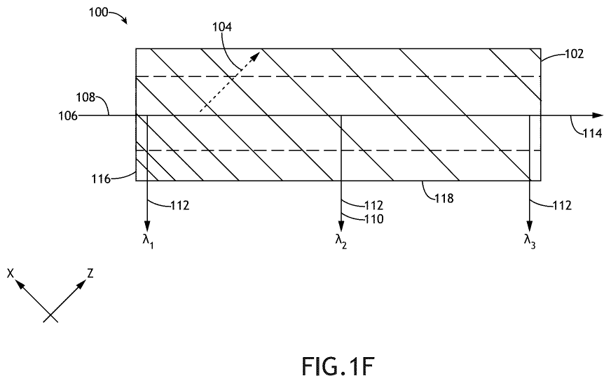

Referring now to FIGS. 1A-3, systems and methods for chirped pulse amplification with at least one r-VBG 100 is described in greater detail, in accordance with one or more embodiments of the present disclosure.

A VBG may be formed as a grating structure associated within the volume of material 102 with a periodic variation of refractive index along a grating vector direction

$$104 k = \frac{2 π}{d} .$$

The material may include a photosensitive material or any other suitable material. This grating structure is typically extended in directions perpendicular to the grating vector direction 104. Put another way, a VBG may typically have a constant refractive index within any plane normal to the grating vector direction 104, where the refractive index along the grating vector direction 104 varies periodically. Further, a VBG may generally have any selected variation of the refractive index along the grating vector direction 104 so long as a Bragg condition is satisfied for at least one wavelength in at least a portion of the VBG. For example, the refractive index n of a traditional VBG may be a simple sinusoidal function with a constant (e.g., uniform) period along the grating vector direction 104. As another example, the refractive index n of a chirped VBG may have a variable period along the grating vector direction 104 and may thus satisfy a Bragg condition for different wavelengths at different locations. As another example, the refractive index variation (δn) of an apodized VBG may vary along the grating vector direction 104.

An r-VBG 100 may then be formed as a VBG with a grating vector direction 104 oriented at an angle from an expected incidence direction 106 of input light 108 (e.g., an input beam) or at an angle with respect to an input face 116 of the material in which the VBG is formed. Similarly, an r-VBG 100 may generally have any refractive index distribution along the grating vector direction 104 that satisfies a Bragg condition for light of at least one wavelength incident along the incidence direction 106.

FIG. 1A is a top view of an r-VBG 100 with a uniform period, in accordance with one or more embodiments of the present disclosure. FIG. 1B is a perspective view of the r-VBG 100 of FIG. 1A, in accordance with one or more embodiments of the present disclosure.

In FIGS. 1A and 1B, the grating vector direction 104 corresponds to a Z axis. The refractive index variation of the r-VBG 100 depicted in FIGS. 1A and 1B may then be characterized as:

$$n ( z ) = {n}_{0} + δ n cos ( \frac{2 π}{{Λ}_{0}} \cdot z ) \qquad ( 1 )$$

where n₀ is an average refractive index of a material 102 in which the r-VBG 100 is formed, δn is a refractive index contrast, and Λ₀ is a period of the refractive index variation along the grating vector direction 104. Further, the refractive index at any particular value of z may be constant along a corresponding plane orthogonal to the grating vector direction 104 (e.g., an X-Y plane). It is noted that the figures depict variations of refractive index along the grating vector direction 104 as simple lines, but this is merely illustrative and should not be interpreted as limiting the scope of the present disclosure. It is to be understood that Equation (2) is merely illustrative and not limiting on the scope of the present disclosure. Rather, an r-VBG 100 may include any refractive index distribution suitable for reflecting light via Bragg reflection. For example, as will be described in greater detail below, the period of the refractive index variation (Λ₀) may vary along the grating vector direction 104 (e.g., forming a chirped r-VBG 100). As another example, the refractive index contrast (δn) may also vary along the grating vector direction 104, which is referred to herein as apodization such that an r-VBG 100 with a refractive index contrast (δn) that varies along the grating vector direction 104 is an apodized r-VBG 100. In this configuration, the diffraction efficiency may also vary along the grating vector direction 104.

An r-VBG 100 may reflect light via Bragg diffraction when a Bragg condition is satisfied for a particular wavelength and incidence direction 106 and transmit light otherwise. For example, FIGS. 1A and 1B depict input light 108 along an incidence direction 106, where a portion of the input light 108 is reflected via Bragg diffraction along a reflection direction 110 (e.g., as reflected light 112) and a portion of the input light 108 is transmitted along the input light 108 (e.g., as transmitted light 114). Notably, the incidence direction 106 and the reflection direction 110 lie within a diffraction plane (e.g., a plane of diffraction) formed by the grating vector direction 104 and the incidence direction 106. In FIGS. 1A and 1B, the diffraction plane corresponds to the X-Z plane. Notably, reflected light 112 and transmitted light 114 also lie within the diffraction plane.

The reflected light 112 may be spatially extended (e.g., spatially chirped) along the incidence direction 106 as demonstrated in FIG. 1A. The extent of the spatial chirp along the incidence direction 106 may depend on various factors such as, but not limited to, a diffraction efficiency of Bragg diffraction that produces the reflected light 112. In this way, the depiction of six rays of reflected light 112 in FIG. 1A is merely illustrative and should not be interpreted as limiting the present disclosure. Further, the depiction of the location of the reflected light 112 along the incidence direction 106 is also merely illustrative and should not be interpreted as limiting the present disclosure. Some figures depict reflected light 112 as a single ray, but this is again for illustrative purposes and should not be interpreted as limiting the present disclosure.

The reflected wavelength (e.g., a wavelength at which a Bragg condition is satisfied) may be characterized by:

λ(φ)=2Λ₀\sqrt{n₀²−sin²φ} (2)

where φ is an angle between the grating vector direction 104 and an incidence direction 106. Equation (2) illustrates that the reflected wavelength decreases as the angle φ increases between 0 and 45 degrees. Further, for the particular case of φ=45°, the reflected wavelength is λ(45°)=\sqrt{2}Λ₀n₀.

It is contemplated herein that the material 102 in which an r-VBG 100 is formed may have any shape and/or any number of faces at any orientation with respect to the grating vector direction 104. In some embodiments, an r-VBG 100 and one or more faces of the material 102 are co-designed to provide that light propagates normally through one or more faces. Such a configuration may be useful for, but not limited to, mitigating dispersion at the face. For example, as depicted in FIG. 1A, the grating vector direction 104 may be oriented at a non-zero angle with respect to a normal of an input face 116, which may be suitable for, but not limited to, applications in which input light 108 is expected to propagate through the input face 116 at normal incidence. As another example, as also depicted in FIG. 1A, an output face 118 may be oriented such that reflected light 112 (e.g., of a known wavelength based on a known incidence direction 106) exits the material 102 through the output face 118 at normal incidence.

Referring now to FIG. 1C, the properties of an r-VBG 100 with a non-uniform refractive index distribution along the grating vector direction 104 (e.g., a chirped distribution) is described.

As indicated previously herein, an r-VBG 100 may generally have any refractive index distribution along the grating vector direction 104 that satisfies a Bragg condition for light of at least one wavelength propagating along an incidence direction 106 that is different than the grating vector direction 104. In some embodiments, a period of the refractive index variation varies monotonically along the grating vector direction 104 (e.g., monotonically increases or decreases). For example, the period may vary linearly, quadratically, or by any other distribution. An r-VBG 100 with a non-uniform refractive index variation along the grating vector direction 104 may be referred to as a rotated chirped Volume Bragg grating and may be abbreviated as r-CVBG or r-CBG.

FIG. 1C is a top view of an r-VBG 100 with linear chirp along the grating vector direction 104, in accordance with one or more embodiments of the present disclosure. For example, the refractive index variation of an r-VBG 100 with linear chirp may be characterized as:

$$n ( z ) = {n}_{0} + δ n cos \{ Qz + {β ( z - 0.5 L )}^{2} \} \qquad ( 3 )$$

$$where Q \approx \frac{4 π}{{λ}_{0}} {n}_{0} ,$$

β is a chirp rate, and L is a length of the r-VBG 100 along the incidence direction 106.

In this configuration, different wavelengths are reflected by the r-VBG 100 at different depths along the incidence direction 106. Put another way, the Bragg condition may be satisfied for different wavelengths at different depths along the incidence direction 106. This is illustrated in FIG. 1C by a first ray of reflected light 112-1 with a first wavelength λ₁ at a first depth along the incidence direction 106, a second ray of reflected light 112-2 with a second wavelength λ₂ at a second depth along the incidence direction 106, and a third ray of reflected light 112-3 with a third wavelength λ₃ at a third depth along the incidence direction 106. More particularly, it can be shown for the configuration of FIG. 1C that the reflected wavelength may be characterized as:

$$λ ( z ) = {λ}_{0} - γ z , and \qquad ( 4 )$$

$$γ = \frac{{λ}_{0}^{2}}{2 π {n}_{0}} β , \qquad ( 5 )$$

where λ₀ is a first reflected wavelength.

As a result, the reflected light 112 may be spectrally chirped (e.g., spectrally resolved) along the incidence direction 106 and also temporally chirped due to the difference in path lengths as a function of wavelength. A spectrally resolved bandwidth Δλ (e.g., a resolution of the r-VBG 100) may be characterized as:

$$Δ λ = \frac{{n}_{0} \vert γ \vert}{\sqrt{{n}_{0}^{2} - {sin}^{2} ϕ}} \cdot L . \qquad ( 6 )$$

Accordingly, the resolved bandwidth may generally be increased by increasing the length of the r-VBG 100 along the incidence direction 106 (L). The primary constraint on the width W of the r-VBG 100 orthogonal to the incidence direction 106 is diffraction as it propagates along the incidence direction 106.

Referring now to FIG. 1D, the fabrication of multiple r-VBGs 100 within a common volume of material 102 (e.g., multiplexed fabrication) is described in greater detail, in accordance with one or more embodiments of the present disclosure.

In a general sense, any number of r-VBGs 100 of any type (e.g., uniform, chirped, or the like) may be fabricated in a common volume of a material 102. Further, each r-VBG 100 may have a grating vector direction 104 along any selected direction. For example, multiple r-VBGs 100 may be fabricated within a common volume that have a common grating vector direction 104 but different refractive index distributions along the common grating vector direction 104 (e.g., different uniform periods, different chirp rates, or the like). Such a configuration may be suitable for, but not limited to, generating multiple beams of reflected light 112 out of a single output face. As another example, multiple r-VBGs 100 may be fabricated within a common volume that have different grating vector directions 104, where the r-VBGs 100 may have the same or different refractive index distributions along the respective grating vector directions 104. Such a configuration may be suitable for, but not limited to, generating multiple beams of reflected light 112 that propagate along different directions and potentially out of different output faces.

FIG. 1D is a top view of a material 102 including two multiplexed chirped r-VBGs 100 with different grating vector directions 104, in accordance with one or more embodiments of the present disclosure. In particular, FIG. 1D depicts a first r-VBG 100-1 with a first refractive index distribution along a first grating vector direction 104-1 and a second refractive index distribution along a second r-VBG 100-2 with second grating vector direction 104-2. In FIG. 1D, the first grating vector direction 104-1 is orthogonal to the second grating vector direction 104-2 and oriented at 45-degrees relative to the incidence direction 106. In this way, the first r-VBG 100-1 may generate first reflected light 112-1 through 112-3 having a first wavelength distribution (represented as λ₁ through λ₃) that exits through a first output face 118-1, whereas the second r-VBG 100-2 may generate second reflected light 112-4 through 112-6 having a second wavelength distribution (represented as λ₄ through λ₆) that exits through a second output face 118-2.

It is to be understood that the particular configuration depicted in FIG. 1D and the associated description are merely illustrative and should not be interpreted as limiting the scope of the present disclosure. In general, multiple r-VBGs 100 with different chirp distributions may have any grating vector directions 104 and may reflect light within any overlapping or non-overlapping spectral bands. Further, although not shown, uniform and chirped r-VBGs 100 may be multiplexed within a common volume.

Referring generally to FIGS. 1A-1F, additional aspects of r-VBGs 100 are now described in greater detail. An r-VBG 100 may be fabricated in any material 102 that has transparency for the wavelength or wavelengths of interest including, but not limited to, wavelengths in ultraviolet, visible, or infrared spectral regions. This includes but is not limited to glasses, crystals, polymers, sol-gels, and others. Further, an r-VBG 100 may be fabricated using any technique known in the art such as, but not limited to, holographic recording techniques or direct laser writing techniques (e.g., femtosecond laser direct writing techniques).

In some embodiments, an r-VBG 100 is fabricated within a waveguide 120. FIG. 1E is a simplified top view of an r-VBG 100 within a waveguide 120, in accordance with one or more embodiments of the present disclosure. In FIG. 1E, the material 102 in which an r-VBG 100 is formed operates as a waveguide 120 and is at least partially surrounded by cladding material 122 providing a refractive index differential suitable for guiding light.

The waveguide 120 and surrounding cladding material 122 may have any structure known in the art suitable for guiding light. Further, the waveguide 120 may be surrounded by any material or combination of materials having lower refractive index than the waveguide 120. In some embodiments, the waveguide 120 including the r-VBG 100 is fully surrounded by one or more cladding materials 122. Such a configuration may be, but is not required to be, characterized as an embedded waveguide. For example, the waveguide 120 including the r-VBG 100 may be buried within the volume of bulk material 102. As another example, the waveguide 120 including the r-VBG 100 may be fabricated on a substrate and/or film and be surrounded by a cap layer having the same or different composition as the substrate and/or film. As another example, the waveguide 120 including the r-VBG 100 may the core of an optical fiber. In some embodiments, the waveguide 120 including the r-VBG 100 is partially surrounded by cladding material 122. Such a configuration may be, but is not required to be, characterized as a rib waveguide or a ridge waveguide.

In some embodiments, a waveguide 120 is fabricated within an r-VBG 100. FIG. 1F is a simplified top view of a waveguide 120 within an r-VBG 100, in accordance with one or more embodiments of the present disclosure. In this configuration, light may be guided as it propagates through the r-VBG 100 along the incidence direction 106.

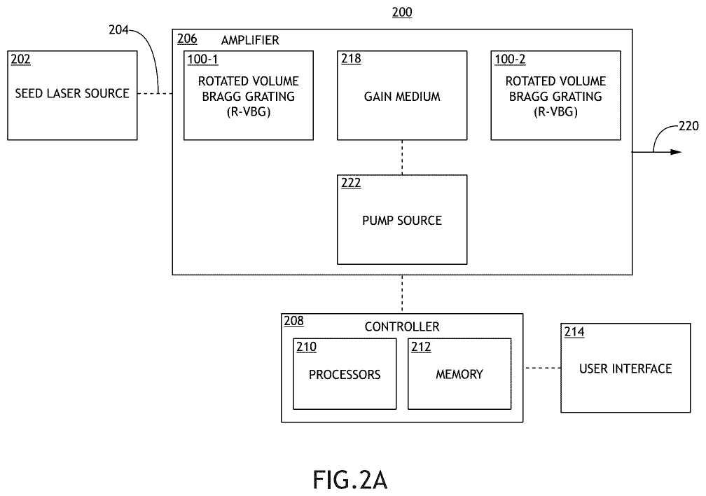

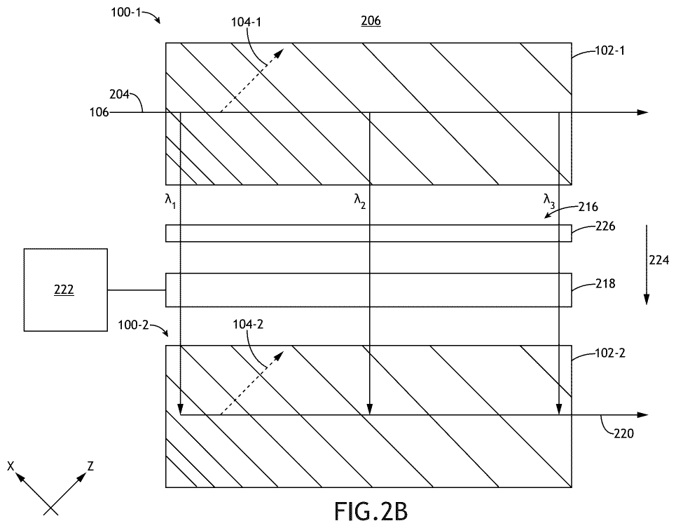

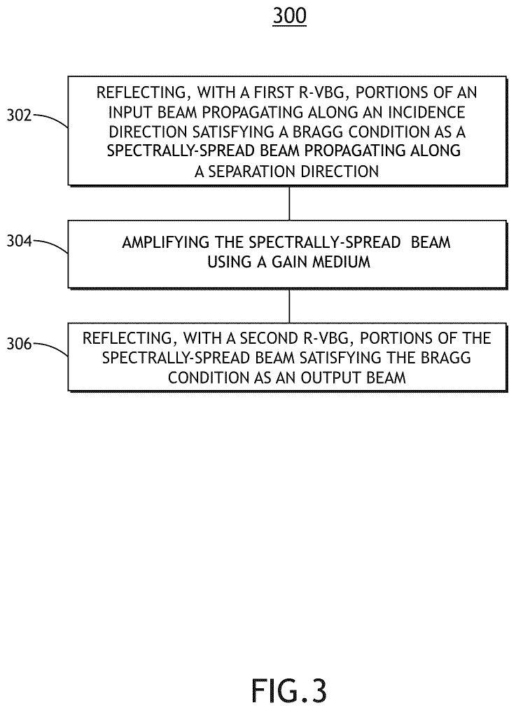

Referring now to FIGS. 2A-3, systems and methods for chirped pulse amplification using one or more r-VBGs 100 is described in greater detail, in accordance with one or more embodiments of the present disclosure.

FIG. 2A is a block diagram of a laser 200 utilizing chirped pulse amplification with a pair of r-VBGs 100, in accordance with one or more embodiments of the present disclosure.

In some embodiments, the laser 200 includes a seed laser source 202 to generate a pulsed seed beam 204 and an amplifier 206 configured to amplify the seed beam 204 using chirped pulse amplification.

In some embodiments, the laser 200 further includes a controller 208 with one or more processors 210 configured to execute program instructions maintained on memory 212 (e.g., a memory medium). In some embodiments, the laser 200 includes a user interface 214, which may provide (e.g., display) data to a user and/or may receive input from a user.

The seed laser source 202 may include any laser source known in the art suitable for generating a seed beam 204 including multiple laser pulses. Further, the seed laser source 202 may be provided in any form factor. For example, the seed laser source 202 may incorporate bulk optical components and/or optical fibers. In some embodiments, the seed laser source 202 is a laser oscillator. In some embodiments, the seed laser source 202 is an amplified laser. In this configuration, the amplifier 206 may be one stage in multi-stage amplifier system.

The seed beam 204 may include pulses with any temporal duration. For example, the seed beam 204 may include pulses with pulse durations on the order of nanoseconds, picoseconds, femtoseconds, or attoseconds. In this way, the seed laser source 202 may be, but is not required to be, characterized as an ultrashort-pulse laser (or an ultrashort laser) and the seed beam 204 as an ultrashort-pulse beam. In some embodiments, the seed beam 204 includes pulses with pulse durations shorter than 1 nanosecond. In some embodiments, the seed beam 204 includes pulses with pulse durations shorter than 100 picoseconds. In some embodiments, the seed beam 204 includes pulses with pulse durations shorter than 1 picosecond. In some embodiments, the seed beam 204 includes pulses with pulse durations shorter than 100 femtoseconds. In some embodiments, the seed beam 204 includes pulses with pulse durations shorter than 10 femtoseconds. In some embodiments, the seed beam 204 includes pulses with pulse durations shorter than 1 femtosecond.

FIG. 2B is a block diagram of an amplifier 206, in accordance with one or more embodiments of the present disclosure.

In some embodiments, an amplifier 206 includes a first chirped r-VBG 100-1 to spatially spread a spectrum of input light 108 as a spectrally-spread beam 216, a gain medium 218 configured to provide optical amplification of the spectrally-spread beam 216 when pumped, and a second chirped r-VBG 100-2 to collect the spectrally-spread beam 216 from the gain medium 218 and compress the spectrum of the spectrally-spread beam 216 and to provide an output beam 220 having substantially the same beam profile as the input light 108.

Notably, the spectral spreading of the seed beam 204 into by the first r-VBG 100-1 may decrease a peak intensity of the associated pulses through spatial and temporal stretching. For instance, the spectrally-spread beam 216 may be spatially spread along the incidence direction 106 and temporally spread due to the different propagation distances of the different portions of the spectrally-spread beam 216. As a result, such a configuration may be highly effective for chirped-pulse amplification.

In some embodiments, pulses in the output beam 220 have the same pulse duration as pulses in the seed beam 204. However, this is not a requirement and in some cases the pulses in the output beam 220 are shorter or longer than pulses in the seed beam 204.

In some embodiments, the output beam 220 propagates along a direction parallel to the incidence direction 106 of the input light 108.

The gain medium 218 may include any component or combination of components suitable for providing optical gain when pumped such as, but not limited to, a glass, a crystal, or a semiconductor. Further, the gain medium 218 may be pumped using any technique known in the art including, but not limited to, optical pumping (e.g., with pump light) or electrical pumping.

Further, the gain medium 218 may have any composition suitable for providing a population inversion and optical gain. It is contemplated herein that many compositions may be suitable for use as a gain medium 218 and the scope of the present disclosure is not limited to any particular gain medium 218 or associated laser technology. Non-limiting illustrations of a gain medium 218 include titanium-sapphire crystals, ytterbium-doped materials, or chromium-doped materials.

In some embodiments, the laser 200 further includes one or more pump sources 222 to pump the gain medium 218. Again, any type of pumping is within the spirit and scope of the present disclosure. For example, a pump source 222 may include one or more optical sources to provide pump light for optical pumping. Any suitable pump source 222 may be utilized such as, but not limited to, a laser (e.g., a diode laser). As another example, a pump source 222 may include one or more electrical sources to provide electrical pumping.

Although not explicitly shown, the laser 200 may include various additional components to manipulate the seed beam 204 and/or the pump light. For example, the laser 200 may include lenses, mirrors, polarizers, polarization rotators, optical isolators, or the like. As another example, the laser 200 may include one or more pulse pickers to select certain pulses from the seed beam 204 for amplification. For instance, it may be desirable to amplify a single pulse of the seed beam 204 and/or reduce a repetition rate of the seed beam 204.

Various aspects of the amplifier 206 will now be described in greater detail, in accordance with one or more embodiments of the present disclosure.

As described previously herein with respect to FIG. 1C, the first chirped r-VBG 100-1 may reflect light that satisfies a Bragg condition (e.g., as reflected light 112), where the Bragg condition is satisfied at different depths along the incidence direction 106 for different wavelengths. In the context of the amplifier 206, the spectrally-spread beam 216 refers to the reflected light 112 from the first r-VBG 100-1.

Further, the reflection direction 110 of the first r-VBG 100-1 is referred to as a separation direction 224 (e.g., describing a separation between the first r-VBG 100-1 and the second r-VBG 100-2).

As a result, a spatial distribution of the spectral components of the spectrally-spread beam 216 (and thus the amount of spatial and/or temporal stretching achieved) may be controlled by the distribution of the refractive index variation of the chirped r-VBG 100. Notably, while it may be convenient to describe the refractive index variation of a chirped r-VBG 100 along its grating vector direction 104 (e.g., as provided in Equation (3)), the spatial distribution of the spectral components of the spectrally-spread beam 216 may be more directly related to the refractive index variation along the incidence direction 106.

The second r-VBG 100-2 may then have the same distribution of refractive index variations as the first r-VBG 100-1 such that the second r-VBG 100-2 may reverse the spectral spreading provided by the first r-VBG 100-1 and thus compress the amplified spectrally-spread beam 216 both spatially and temporally. In this way, the first r-VBG 100-1 and the second r-VBG 100-2 may be characterized as a pair of r-VBGs 100.

In a general sense, an amplifier 206 may include any pair of chirped r-VBGs 100 (e.g., the first r-VBG 100-1 and the second r-VBG 100-2) having any refractive index distribution with a non-uniform period. In some embodiments, the refractive index distribution of a chirped r-VBG 100 in an amplifier 206 varies monotonically along the grating vector direction 104 (and thus monotonically along the incidence direction 106). For example, the refractive index distribution of a pair of chirped r-VBGs 100 in an amplifier 206 may vary linearly, quadratically, or with any other monotonic distribution along the grating vector direction 104.

As depicted in FIG. 2B, the spatial spread of the spectral components in the spectrally-spread beam 216 along the incidence direction 106 is based on the distribution of the period of the refractive index variation along the incidence direction 106, which has multiple benefits.

For example, the spectrally-spread beam 216 may be collimated or slowly diverging as it propagates along the separation direction 224 such that the spatial spread of the spectrum of the input light 108 does not change (or changes slowly) with distance from the chirped r-VBG 100. As a result, no free-space propagation, lenses, or other components are needed. Rather, the amplifier 206 (or portions thereof) may be placed at any suitable position and may in some cases be in contact with the materials 102 in which the first r-VBG 100-1 and/or the second r-VBG 100-2 are formed. This configuration may thus be extraordinarily compact and may further be physically mounted in a package that is robust to vibrations or other mechanical movements.

As another example, the resolved bandwidth (e.g., a range of wavelengths Δλ that may be captured) may be controlled by the length of the first chirped r-VBG 100-1 along the incidence direction 106 the rate of change of the period of refractive index variation (e.g., the chirp rate β in Equation (3)). Further, the spectral resolution (e.g., a minimum wavelength separation 81 that may be discerned) may be controlled by these parameters as well as a width of the input light 108 in a plane normal to the incidence direction 106, where decreasing the beam width may increase the spectral resolution. As a result, the use of a pair of chirped r-VBGs 100 to spread and then compress the spectrum of the input light 108 may provide substantial flexibility to balance the achievable bandwidth, the spectral resolution, and the overall size of the amplifier 206.

In some embodiments, the amplifier 206 further includes a phase modulator 226 between the pair of r-VBGs 100 to apply any desired phase shifts to the spectrally-spread beam 216. The phase modulator 226 may include component or combination of components suitable for providing a spatially-varying phase modulation to the spectrally-spread beam 216. For example, the phase modulator 226 may include, but is not limited to, a spatial light modulator (SLM).

The pixels of a phase modulator 226 may provide spatial sampling of the spatially spread spectrum of the input light 108 when applying a phase modulation.

In some embodiments, the pair of chirped r-VBGs 100 provide a linearly varying period of refractive index variation. Such a configuration may beneficially provide a spectrally-spread beam 216 with linearly varying wavelength along the incidence direction 106 and may further provide linear sampling of the spectrum by the phase modulator 226 when applying phase modulation to different portions of the spectrally-spread beam 216. However, this is not a requirement and some applications may benefit from non-linear sampling of a spectrum of the spectrally-spread beam 216, which may be achieved through non-linear variations of periods of a chirped pair of r-VBGs 100 along the respective grating vector directions 104 (and thus along the incidence direction 106).

The phase modulator 226 may provide any desired phase modulation profile in one or two dimensions (e.g., as considered in an plane normal to the spectrally-spread beam 216). For example, the phase modulation profile may be spatially non-uniform to introduce different phase delays to different portions of the spectrally-spread beam 216. In this way, the phase modulator 226 may include a one or two-dimensional array of pixels suitable for providing individually-addressable phase modifications. Further, a two-dimensional array of pixels may be configured to provide any 1D or 2D phase modulation profile.

As an illustration, the amplifier 206 may be configured to pre-chirp the output beam 220. In general, an ultrashort laser pulse in the output beam 220 may exhibit pulse broadening as it propagates due to differences in propagation speed of different wavelengths. However, it may be desirable in some applications to provide an ultrashort pulse of the output beam 220 on a target, where the pulse duration is minimized (e.g., as short as it can given its spectrum) at the target.

In some embodiments, the amplifier 206 is configured to introduce negative chirp to pulses in the spectrally-spread beam 216 such that the pulses of the output beam 220 may have a desired (e.g., minimized) pulse duration after propagation a selected distance through a selected medium.

Referring again to FIG. 2, various additional aspects of the amplifier 206 are described in greater detail, in accordance with one or more embodiments of the present disclosure.

The controller 208 may be communicatively coupled to any component of the amplifier 206 and/or any external systems. In this way, the controller 208 may receive data from and/or direct (e.g., via control signals) any of the components of the laser 200 such as, but not limited to, the seed laser source 202, the one or more pump sources 222, the amplifier 206, or a phase modulator 226. Further, the program instructions may cause the processors 210 to execute various actions or process steps as disclosed herein.

The one or more processors 210 of a controller 208 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 210 may include any device configured to execute algorithms and/or instructions (e.g., program instructions stored in memory). In one embodiment, the one or more processors 210 may be embodied as a desktop computer, mainframe computer system, workstation, image computer, parallel processor, networked computer, or any other computer system configured to execute a program configured to operate or operate in conjunction with the amplifier 206, as described throughout the present disclosure

Moreover, different components of the amplifier 206 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 208 may be formed as one or more controllers housed in a common housing or within multiple housings. In this way, any controller or combination of controllers may be separately packaged as a module suitable for integration into the amplifier 206.

The memory 212 may include any storage medium known in the art suitable for storing program instructions executable by the associated one or more processors 210. For example, the memory 212 may include a non-transitory memory medium. By way of another example, the memory 212 may include, but is not limited to, a read-only memory (ROM), a random-access memory (RAM), a magnetic or optical memory device (e.g., disk), a magnetic tape, a solid-state drive and the like. It is further noted that memory 212 may be housed in a common controller housing with the one or more processors 210. In one embodiment, the memory 212 may be located remotely with respect to the physical location of the one or more processors 210 and controller 208. For instance, the one or more processors 210 of controller 208 may access a remote memory (e.g., server), accessible through a network (e.g., internet, intranet and the like).

The user interface 214 may include any component or combination of components known in the art suitable for providing information to a user and/or receiving inputs from a user. For example, the user interface 214 may include, but is not limited to, one or more desktops, laptops, tablets, and the like. In embodiments, the user interface 214 includes a display used to display data to a user. The display of the user interface 214 may include any display known in the art. For example, the display may include, but is not limited to, a liquid crystal display (LCD), an organic light-emitting diode (OLED) based display, or a CRT display. Those skilled in the art should recognize that any display device capable of integration with a user interface 214 is suitable for implementation in the present disclosure. In embodiments, a user may input selections and/or instructions responsive to data displayed to the user via a user input device of the user interface 214 such as, but not limited to, a keyboard, a mouse, a touchscreen, or an audio interface (e.g., a voice interface suitable for accepting audio commands from a user).

Referring now to FIG. 3, FIG. 3 is a flow diagram illustrating steps performed in a method 300 for light amplification using a pair of chirped r-VBGs 100, in accordance with one or more embodiments of the present disclosure. Applicant notes that the embodiments and enabling technologies described previously herein in the context of the amplifier 206 should be interpreted to extend to the method 300. It is further noted, however, that the method 300 is not limited to the architecture of the amplifier 206.

In some embodiments, the method 300 includes a step 302 of reflecting, with a first r-VBG 100-1, portions of an input beam (e.g., input light 108) propagating along an incidence direction 106 satisfying a Bragg condition as a spectrally-spread beam 216 propagating along a separation direction 224, wherein the Bragg condition is satisfied for different wavelengths at different locations of the first r-VBG 100-1 along the incidence direction 106 to provide that a spectrum of the spectrally-spread beam 216 is dispersed along the incidence direction 106. In this way, the spectrally-spread beam 216 may be spatially and temporally spread in order to reduce a peak intensity of pulses within the spectrally-spread beam 216.

In some embodiments, the method 300 includes a step 304 of amplifying the spectrally-spread beam 216 using a gain medium 218.

In some embodiments, the method 300 includes a step 306 of reflecting, with a second r-VBG 100-2, portions of the spectrally-spread beam 216 satisfying the Bragg condition as an output beam 220, wherein the second r-VBG 100-2 is positioned to provide that the Bragg condition is satisfied for different wavelengths at different locations along the incidence direction 106 to provide that the spectrally-spread beam 216 is spectrally recombined into an output beam 220. In this way, the output beam 220 may be spatially and temporally compressed.

In some embodiments, though not shown, the method 300 includes a step of applying, with a phase modulator 226, a spatially non-uniform phase distribution to the spectrally-spread beam 216. Any one-dimensional or two-dimensional phase distribution is within the spirit and scope of the present disclosure. For example, negative chirp may be applied to the spectrally-spread beam 216 such that pulses within the output beam 220 may be spatially and temporally compressed (or have any selected pulse duration more generally) after propagating a selected distance through a selected material.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A device comprising:
two rotated volume Bragg gratings (r-VBGs) formed as planes of refractive index variation with periodicity along parallel grating vectors, wherein periods of the two r-VBGs are chirped along the respective grating vectors to vary along the respective grating vectors, wherein the two r-VBGs are spatially separated along a separation direction oriented at a non-zero angle to the grating vectors; and
a gain medium between the two r-VBGs;
wherein a first of the two r-VBGs is configured to reflect portions of an input beam from a seed laser source propagating along an incidence direction satisfying a Bragg condition into the separation direction as a spectrally-spread beam, wherein the Bragg condition is satisfied for different wavelengths at different locations of the first r-VBG along the incidence direction to provide that a spectrum of the spectrally-spread beam is dispersed along the incidence direction;
wherein the gain medium amplifies the spectrally-spread beam when pumped; and
wherein a second of the two r-VBGs is configured to reflect portions of the spectrally-spread beam satisfying the Bragg condition into the incidence direction, wherein the second r-VBG is positioned to provide that the Bragg condition is satisfied for different wavelengths at different locations of the first r-VBG along the incidence direction to provide that the spectrally-spread beam is spectrally recombined into an output beam.

2. The device of claim 1, wherein a pulse duration of at least one of the seed beam or the output beam is shorter than 1 picosecond.

3. The device of claim 1, wherein a pulse duration of at least one of the seed beam or the output beam is shorter than 100 femtoseconds.

4. The device of claim 1, further comprising:
a phase modulator between the two r-VBGs with a spatially non-uniform phase distribution in a plane orthogonal to the separation direction.

5. The device of claim 4, wherein the first r-VBG is formed in a first material, wherein the second r-VBG is formed in a second material, wherein the phase modulator is located between the first and second r-VBGs without intervening components.

6. The device of claim 4, wherein the phase modulator is in physical contact with at least one of the first or second r-VBGs.

7. The device of claim 4, wherein the two r-VBGs and the phase modulator are formed in a single material.

8. The device of claim 4, wherein the phase modulator is a two-dimensional phase modulator.

9. The device of claim 4, wherein the phase modulator is a one-dimensional phase modulator.

10. The device of claim 4, wherein the input beam is a laser pulse, wherein the spatially non-uniform phase distribution of the phase modulator is selected to apply negative chirp to the laser pulse.

11. The device of claim 1, wherein the non-zero angle is 45 degrees.

12. A device comprising:
a seed laser source configured to generate an input beam;
two rotated volume Bragg gratings (r-VBGs) formed as planes of refractive index variation with periodicity along parallel grating vectors, wherein periods of the two r-VBGs are chirped along the respective grating vectors to vary along the respective grating vectors, wherein the two r-VBGs are spatially separated along a separation direction oriented at a non-zero angle to the grating vectors; and
a gain medium between the two r-VBGs;
wherein a first of the two r-VBGs is configured to reflect portions of the input beam from the seed laser source propagating along an incidence direction satisfying a Bragg condition into the separation direction as a spectrally-spread beam, wherein the Bragg condition is satisfied for different wavelengths at different locations of the first r-VBG along the incidence direction to provide that a spectrum of the spectrally-spread beam is dispersed along the incidence direction;
wherein the gain medium amplifies the spectrally-spread beam when pumped; and
wherein a second of the two r-VBGs is configured to reflect portions of the spectrally-spread beam satisfying the Bragg condition into the incidence direction, wherein the second r-VBG is positioned to provide that the Bragg condition is satisfied for different wavelengths at different locations of the first r-VBG along the incidence direction to provide that the spectrally-spread beam is spectrally recombined into an output beam.

13. A method comprising:
reflecting, with a first rotated volume Bragg grating (r-VBG), portions of an input beam propagating along an incidence direction satisfying a Bragg condition as a spectrally-spread beam propagating along a separation direction, wherein the Bragg condition is satisfied for different wavelengths at different locations of the first r-VBG along the incidence direction to provide that a spectrum of the spectrally-spread beam is dispersed along the incidence direction;
amplifying the spectrally-spread beam using a gain medium; and
reflecting, with a second r-VBG, portions of the spectrally-spread beam satisfying the Bragg condition as an output beam, wherein the second r-VBG is positioned to provide that the Bragg condition is satisfied for different wavelengths at different locations of the first r-VBG along the incidence direction to provide that the spectrally-spread beam is spectrally recombined into the output beam propagating along the incidence direction;
wherein the first and second r-VBGs are formed as planes of refractive index variation with periodicity along parallel grating vectors, wherein periods of the two r-VBGs are chirped along the respective grating vectors to vary along the respective grating vectors, wherein the two r-VBGs are spatially separated along the separation direction oriented at a non-zero angle to the grating vectors.

14. The method of claim 13, wherein a pulse duration of at least one of the seed beam or the output beam is shorter than 1 picosecond.

15. The method of claim 13, wherein a pulse duration of at least one of the seed beam or the output beam is shorter than 100 femtoseconds.

16. The method of claim 13, further comprising:
a phase modulator between the two r-VBGs with a spatially non-uniform phase distribution in a plane orthogonal to the separation direction.

17. The method of claim 16, wherein the first r-VBG is formed in a first material, wherein the second r-VBG is formed in a second material, wherein the phase modulator is located between the first and second r-VBGs without intervening components.

18. The method of claim 16, wherein the phase modulator is in physical contact with at least one of the first or second r-VBGs.

19. The method of claim 16, wherein the two r-VBGs and the phase modulator are formed in a single material.

20. The method of claim 16, wherein the phase modulator is a two-dimensional phase modulator.

21. The method of claim 16, wherein the phase modulator is a one-dimensional phase modulator.

22. The method of claim 16, wherein the input beam is a laser pulse, wherein the spatially non-uniform phase distribution of the phase modulator is selected to apply negative chirp to the laser pulse.

23. The method of claim 13, wherein the non-zero angle is 45 degrees.
